(19) United States
(12) Patent Application Publication
(10) Pub. No.: US 2014/0173228 A1
(43) Pub. Date: Jun. 19, 2014

(54) MEMORY SYSTEM AND SYSTEM ON CHIP INCLUDING THE SAME

(71) Applicant: Samsung Electronics Co., Ltd., Suwon-Si (KR)

(72) Inventors: Dong-Han LEE, Seongnam-si (KR); Jae-Sop KONG, Gwacheon-si (KR)

(73) Assignee: SAMSUNG ELECTRONICS CO., LTD., Suwon-Si (KR)

(21) Appl. No.: 14/072,208

(22) Filed: Nov. 5, 2013

(30) Foreign Application Priority Data
Dec. 18, 2012 (KR) 10-2012-0148210

(51) Int. Cl. G06F 12/02

(52) U.S. Cl. CPC G06F 12/02
USPC 711/159

(57) ABSTRACT

In one example embodiment, a memory system includes a hierarchical first-in first-out (FIFO) memory configured to store data, and a FIFO controller configured to control inputting and outputting of data to and from the FIFO memory, wherein the FIFO memory includes a first layer. The first layer includes a high-speed input FIFO memory configured to receive data from an external device and a high-speed output FIFO memory configured to output data to the external device. The FIFO memory further includes a second layer. The second layer includes a main FIFO memory configured to receive data from the high-speed input FIFO memory and output data to the high-speed output FIFO memory.

This application claims priority from Korean Patent Application No. 10-2012-0148210 filed on Dec. 18, 2012 in the Korean Intellectual Property Office, the disclosure of which is incorporated herein by reference in its entirety.

### BACKGROUND

1. Field of the Invention

Example embodiments relate to a memory system and a system on chip (SoC) including the same.

2. Description of the Related Art

A first-in first-out (FIFO) memory device is a device that stores data in a FIFO manner. The FIFO memory device manages data input and output using a write pointer and a read pointer. The FIFO memory device is being used variously in semiconductor systems such as a system on chip (SoC).

As the size of data processed by a system increases, a high-performance memory device operating at a high frequency is required. For a memory device to operate at a high frequency, a FIFO memory should be accessible at a high frequency. However, as the storage capacity of the FIFO memory increases, the time required to access the FIFO memory also increases. This presents a challenge to implement a high-frequency memory device.

### SUMMARY

Some example embodiments provide a first-in first-out (FIFO) memory system which includes high-speed, low-capacity input and output FIFO memories and a low-speed, high-capacity main FIFO memory organized in a hierarchical structure to receive and transmit data from and to an external device at high speed and a system on chip (SoC) including the FIFO memory system.

In one example embodiment, a memory system includes a hierarchical first-in first-out (FIFO) memory configured to store data, and a FIFO controller configured to control inputting and outputting of data to and from the FIFO memory, wherein the FIFO memory includes a first layer. The first layer includes a high-speed input FIFO memory configured to receive data from an external device and a high-speed output FIFO memory configured to output data to the external device. The FIFO memory further includes a second layer. The second layer includes a main FIFO memory configured to receive data from the high-speed input FIFO memory and output data to the high-speed output FIFO memory.

In yet another example embodiment, the FIFO controller includes an input FIFO manager configured to input data to the high-speed input FIFO memory, input data to the high-speed input FIFO memory, and input the output data to the main FIFO memory.

In yet another example embodiment, the FIFO controller further includes an output FIFO manager configured to output data to the external device, wherein the input FIFO manager, outputs data stored in the high-speed input FIFO memory and transmits the output data to the output FIFO manager in response to a request from the output FIFO manager.

In yet another example embodiment, the FIFO controller further includes an output FIFO manager configured to output data to the external device, wherein the input FIFO manager immediately transmits data destined for the high-speed input FIFO memory to the output FIFO manager in response to a request from the output FIFO manager.

In yet another example embodiment, the FIFO controller includes an output FIFO manager configured to output data stored in the main FIFO memory, input the output data to the high-speed output FIFO memory and output data from the high-speed output FIFO memory.

In yet another example embodiment, the FIFO memory is further configured to provide a virtual write pointer and a virtual read pointer to the external device.

In yet another example embodiment, the FIFO memory is further configured to provide a write pointer and a read pointer corresponding to each of the high-speed input FIFO memory, the high-speed output FIFO memory, and the main FIFO memory.

In yet another example embodiment, a length of a storage unit of the main FIFO memory is n times a length of a storage unit of the high-speed input FIFO memory and a length of a storage unit of the high-speed output FIFO memory and n is a natural number greater than one.

In yet another example embodiment, the number of storage units of the main FIFO memory is greater than the number of storage units of the high-speed input FIFO memory and the number of storage units of the high-speed output FIFO memory.

In yet another example embodiment, the number of storage units of the high-speed input FIFO memory is greater than the number of storage units of the high-speed output FIFO memory.

In yet another example embodiment, the high-speed input FIFO memory and the high-speed output FIFO memory operate at a first frequency and the main FIFO memory operates at a second frequency, the second frequency being different from the first frequency.

In yet another example embodiment, the first frequency is higher than the second frequency.

In one example embodiment, a system on chip (SoC) includes, a first electronic system configured to transmit data, a second electronic system configured to receive the data, and the memory system of claim 1 configured to temporarily store the data between the first electronic system and the second electronic system.

In one example embodiment, a memory includes a first layer, operating at a first frequency, configured to at least one of receive data from an external device and output the data to the external device. The memory further includes a second layer, operating at a second frequency, configured to at least one of receive the data from the first layer and output the data to the first layer.

In yet another example embodiment, the first layer includes an input first-in first-out (FIFO) memory configured to receive the data from the external device and an output FIFO memory configured to output the data to the external device.

In yet another example embodiment, the second layer includes a main FIFO memory configured to at least one of receive the data from the input FIFO memory and output the data to the input FIFO memory.

In yet another example embodiment, a memory system includes the memory wherein the first layer and the second layer form a hierarchical first-in first-out (FIFO) memory. The memory system further includes a FIFO controller configured to control inputting the data to the FIFO memory and outputting the data from the FIFO memory.

In yet another example embodiment, the first frequency has a higher value compared to the second frequency.

In yet another example embodiment, the number of storage units of the input FIFO memory is greater than the number of storage units of the output FIFO memory.

In yet another example embodiment, a length of a storage unit of a main FIFO memory of the second layer is greater than a length of a storage unit of the input FIFO memory and a length of a storage unit of the output FIFO memory.

### BRIEF DESCRIPTION OF THE DRAWINGS

The above and other aspects and features will become more apparent by describing in detail example embodiments thereof with reference to the attached drawings, in which:

FIG. 1 is a block diagram of a memory system, according to an example embodiment;

FIG. 2 is a block diagram of a first-in first-out (FIFO) memory shown in FIG. 1, according to an example embodiment;

FIG. 3 is a block diagram of a FIFO controller shown in FIG. 1, according to an example embodiment;

FIG. 4 is a diagram illustrating the structure of the memory system according to an example embodiment;

FIG. 5 is a diagram illustrating an application example of the structure of the memory system shown in FIG. 4, according to an example embodiment;

FIG. 6 is a diagram illustrating a data output operation of the memory system, according to an example embodiment;

FIG. 7 is a flowchart illustrating a data output method of the memory system, according to an example embodiment;

FIG. 8 is a flowchart illustrating an application example of the data output method of FIG. 7, according to an example embodiment;

FIG. 9 is a diagram illustrating a data input operation of the memory system, according to an example embodiment;

FIG. 10 is a flowchart illustrating a data input method of the memory system, according to an example embodiment;

FIG. 11 is a flowchart illustrating an application example of the data input method of FIG. 10, according to an example embodiment; and

FIG. 12 is a block diagram of a computing system including the memory system of FIG. 1, according to an example embodiment.

### DETAILED DESCRIPTION OF EXAMPLE EMBODIMENTS

Example embodiments will now be described more fully hereinafter with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This present subject matter may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

When an element is referred to as being “connected,' or “coupled,” to another element, it may be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional operations not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

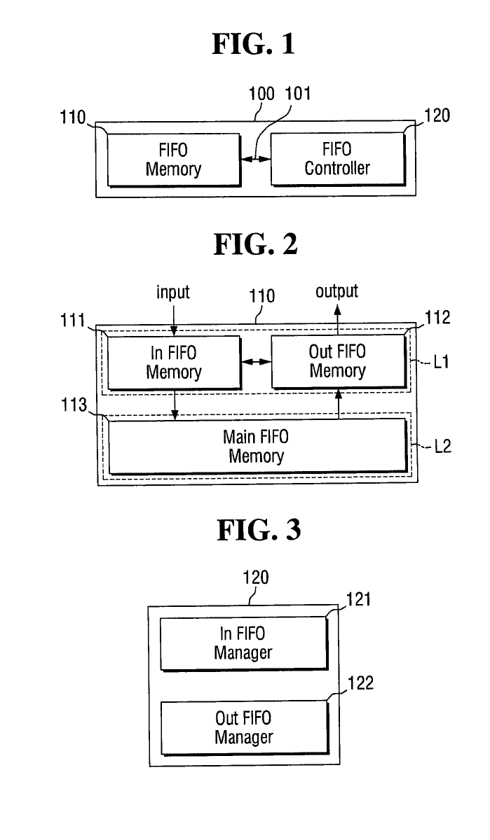

FIG. 1 is a block diagram of a memory system 100, according to an example embodiment. FIG. 2 is a block diagram of a first-in first-out (FIFO) memory 110 shown in FIG. 1, according to an example embodiment. FIG. 3 is a block diagram of a FIFO controller 120 shown in FIG. 1, according to an example embodiment.

Referring to FIG. 1, the memory system 100 according to the example embodiment includes the FIFO memory 110 and the FIFO controller 120.

The FIFO memory 110 is configured to store data and operate in a FIFO manner. The FIFO memory 110 operates in a FIFO manner in which data input first is output first. The FIFO memory 110 provides a write pointer pointing to an address to which input data is to be written and a read pointer pointing to an address from which output data is to be read.

The FIFO controller 120 manages the input and output of data to and from the FIFO memory 110. In the case of data input, the FIFO controller 120 may input data to an address pointed to by the write pointer of the FIFO memory 110 and increase the write pointer. In the case of data output, the FIFO controller 120 may output data stored at an address pointed to by the read pointer of the FIFO memory 110 and increase the read pointer.

The FIFO controller 120 may receive an input command or an output command from an external device (e.g., a bus) and perform a write operation or a read operation according to the received command. The FIFO controller 120 may initialize the FIFO memory 110 by initializing the write pointer and the read pointer of the FIFO memory 110 to zero.

Data may be input to the FIFO memory 110 until a storage space of the FIFO memory 110 becomes full. In addition, data may be output from the FIFO memory 110 until the storage space of the FIFO memory 110 becomes empty. In one example embodiment, when a difference between the write pointer and the read pointer corresponds to a depth of the FIFO memory 110, the FIFO controller 120 may determine that the storage space of the FIFO memory 110 is full. In one example embodiment, when the write pointer and the read pointer point to the same address, the FIFO controller 120 may determine that the storage space of the FIFO memory 110 is empty.

Moreover, the FIFO controller 120 may transmit or receive a write select signal for writing data to the FIFO memory 110, a read select signal for reading data from the FIFO memory 110, a full signal indicating that the storage space of the FIFO memory 110 is completely full, and an empty signal indicating that the storage space of the FIFO memory 110 is completely empty. The transmitting and/or receiving of such signals between the FIFO controller 120 and the FIFO memory 110 may be through a communication link 101. The communication link 101 may be bi-directional or may alternatively be implemented as two separate uni-directional links.

Referring to FIG. 2, the FIFO memory 110 of FIG. 1 is configured hierarchically into a first layer L1 and a second layer L2. The first layer L1 includes an input (In) FIFO memory 111 and an output (Out) FIFO memory 112, and the second layer L2 includes a main FIFO memory 113.

The In FIFO memory 111 may receive data from an external device and store the received data. The Out FIFO memory 112 may output stored data to the external device. The In FIFO memory 111 and the Out FIFO memory 112 may operate at a high-speed first frequency. In one example embodiment, each of the In FIFO memory 111 and the Out FIFO memory 112 may be configured as a 1-port memory, a 2-port memory, or flip-flops. In one example embodiment, each of the In FIFO memory 111 and the Out FIFO memory 112 may also be configured as a register.

The main FIFO memory 113 may receive data from the In FIFO memory 111 and output data to the Out FIFO memory 112. As will be described later, in one example embodiment, the main FIFO memory 113 may function as an actual memory of the memory system 100. The main FIFO memory 113 may operate at a relatively low-speed second frequency. The first frequency may be higher (or greater) than the second frequency. The main FIFO memory 113 may be, but is not limited to, a static random access memory (SRAM).

The In FIFO memory 111, the Out FIFO memory 112, and the main FIFO memory 113 may be configured to operate in a FIFO manner.

Referring to FIG. 3, the FIFO controller 120 of FIG. 1 includes an In FIFO manager 121 and an Out FIFO manager 122.

The In FIFO manager 121 may input data to the In FIFO memory 111 and output data stored in the In FIFO memory 111 to the main FIFO memory 113. The Out FIFO manager 122 may output data stored in the main FIFO memory 113 to the Out FIFO memory 112 and output data from the Out FIFO memory 112.

In FIG. 1, the FIFO memory 110 and the FIFO controller 120 are separated from each other. However, it will be obvious to those of ordinary skill in the art that the FIFO memory 110 and the FIFO controller 120 may be integrated with each other. In one example embodiment, the In FIFO manager 121 of FIG. 3 may be implemented as a part of the In FIFO memory 111, and the Out FIFO manager 122 may be implemented as a part of the Out FIFO memory 112.

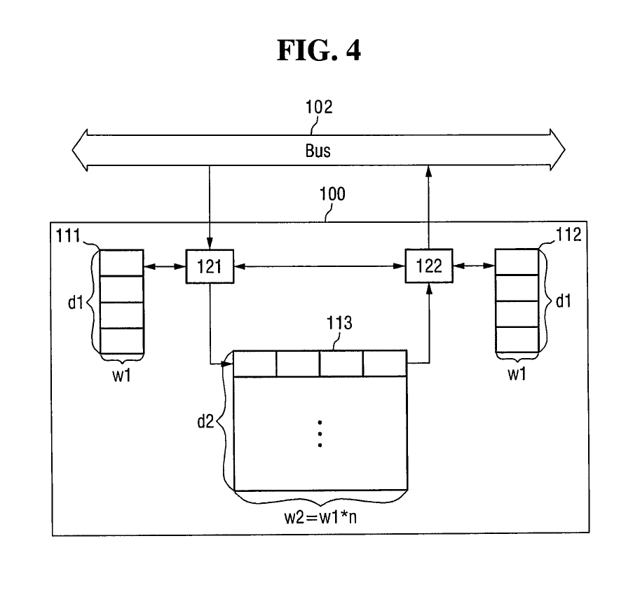

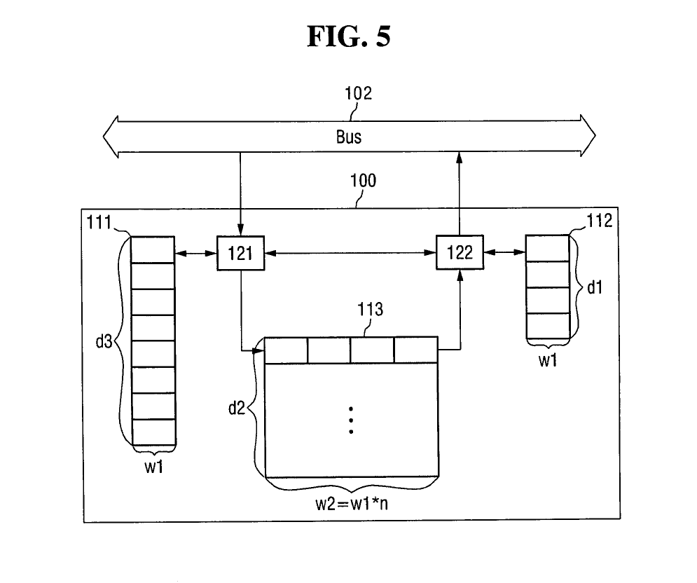

The structure of the memory system 100 according to an example embodiment will now be described with reference to FIGS. 4 and 5.

FIG. 4 is a diagram illustrating the structure of the memory system 100, according to an example embodiment.

Referring to FIG. 4, the memory system 100 according to the example embodiment may be coupled to a bus 102 so as to transmit and receive data.

The memory system 100 may include the In FIFO memory 111, the Out FIFO memory 112, and the main FIFO memory 113 organized in a hierarchical structure. Each of the In FIFO memory 111 and the Out FIFO memory 112 may be configured to have a small storage space and be accessible at high speed. The main FIFO memory 113 may be configured to support a large storage space and be accessible at a relatively low speed.

The In FIFO manager 121 may manage data input to the memory system 100, and the Out FIFO manager 122 may manage data output from the memory system 100.

The In FIFO memory 111 may have a width of w1 and a depth of d1. Like the In FIFO memory 111, the Out FIFO memory 112 may have a width of w1 and a depth of d1. The storage space of the main FIFO memory 113 may have a width of w2 and a depth of d2. Here, a width may indicate a length (e.g., bytes or words) of a storage unit of data, and a depth may indicate the number of storage units of data.

In one example embodiment, since data is output from the Out FIFO memory 112 to an external device, a width of the FIFO memory 110 may be equal to the width w1 of the Out FIFO memory 112. In addition, a depth of the FIFO memory 110 may be equal to the sum of the depth d1 of the In FIFO memory 111, the depth d1 of the Out FIFO memory 112, and the depth d2 of the main FIFO memory 113.

In one example embodiment, the width w2 of the main FIFO memory 113 may be relatively greater than the width w1 of the In FIFO memory 111 and the width w1 of the Out FIFO memory 112. For example, the width w2 of the main FIFO memory 113 may be n (n is a natural number greater than 1) times the width w1 of the In FIFO memory 111 and the width w1 of the Out FIFO memory 112. The depth d2 of the main FIFO memory 113 may be relatively greater than the depth d1 of the In FIFO memory 111 and the depth d1 of the Out FIFO memory 112. In one example embodiment, since the depth d1 of the In FIFO memory 111 and the depth d1 of the Out FIFO memory 112 are far smaller than the depth of the FIFO memory 110, the In FIFO memory 111 and the Out FIFO memory 112 are accessible at high speed.

Accordingly, the memory system 100 according to the current embodiment which includes a plurality of FIFO memories 111 through 113 organized in a hierarchical structure may allow the In FIFO memory 111 and the Out FIFO memory 112 to be accessible at high speed and, at the same time, may provide the large storage space of the main FIFO memory 113.

In one example embodiment, a certain FIFO memory (at least one of the In FIFO memory 111 and the Out FIFO memory 112) may operate at a high frequency, and the main FIFO memory 113 may operate at a low frequency. Therefore, the low-power memory system 100 may be provided.

The memory system 100 may operate regardless of a driving frequency and latency of the main FIFO memory 113. A driving frequency of the memory system 100 may be determined by a driving frequency of the In FIFO memory 111 and a driving frequency of the Out FIFO memory 112. Therefore, if each of the In FIFO memory 111 and the Out FIFO memory 112 is implemented using a high-speed register, the high-performance memory system 100 operating at a high frequency may be provided.

FIG. 5 is a diagram illustrating an application example of the structure of the memory system 100 shown in FIG. 4, according to an example embodiment. For simplicity, the following description will focus on differences from FIG. 4.

Referring to FIG. 5, the In FIFO memory 111 of the memory system 100 may have a depth of d3. In one example embodiment, the depth d3 of the In FIFO memory 111 may be relatively smaller than the depth d2 of the main FIFO memory 113 and may be relatively greater than the depth d1 of the Out FIFO memory 112.

Although not shown in FIGS. 4 and 5, the In FIFO manager 121 may provide an input clock used to input data, and the Out FIFO manager 122 may provide an output clock used to output data. The input clock and the output clock may be synchronous or asynchronous. The input clock and the output clock may operate at the same frequency or different frequencies. When the input clock and the output clock have the same frequency, their phases may be the same or different.

In FIGS. 4 and 5, the memory system 100 according to the current embodiment is coupled to the bus 102, via In FIFO manager 121 and/or Out FIFO manager 122, so as to transmit and receive data.

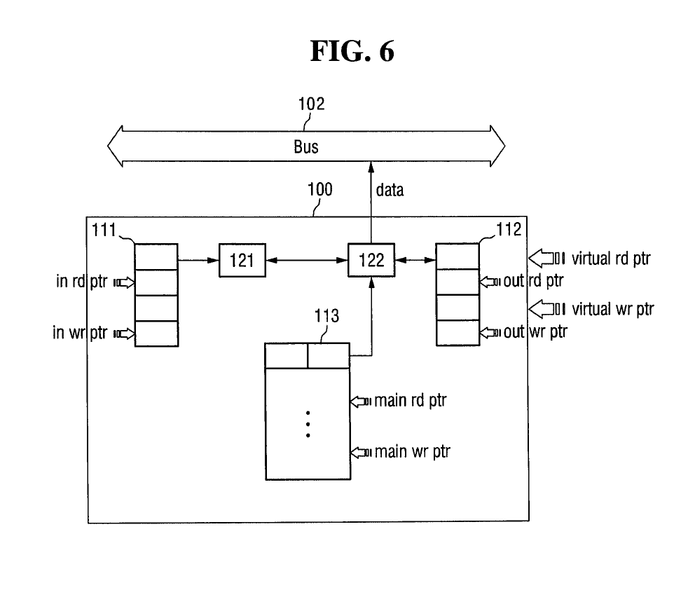

The data input and output operations of the memory system 100 according to an example embodiment will now be described with reference to FIGS. 6 through 11.

For ease of description and for illustration purposes, it will be assumed, hereinafter, that each of the In FIFO memory 111 and the Out FIFO memory 112 of the memory system 100 has four storage units and that the width of the main FIFO memory 113 is twice the width of the In FIFO memory 111 and the width of the Out FIFO memory 112.

FIG. 6 is a diagram illustrating a data output operation of the memory system 100, according to an example embodiment.

Referring to the example embodiment of FIG. 6, the FIFO memory 110 provides a total of eight pointers, and the Out FIFO manager 122 outputs data to an external device using the pointers.

The FIFO memory 110 may provide a virtual write pointer virtual wr ptr and a virtual read pointer virtual rd ptr to the external device. Accordingly, the FIFO memory 110 may provide the same interface as a conventional FIFO memory. Using the virtual pointers virtual wr ptr and virtual rd ptr, the external device may interface with the memory system 100 in a similar manner as accessing a single FIFO memory. In one example embodiment, when a difference between the virtual write pointer virtual wr ptr and the virtual read pointer virtual rd ptr corresponds to the depth of the FIFO memory 110, the FIFO controller 120 may determine that the FIFO memory 110 is full. In one example embodiment, when the virtual write pointer virtual wr ptr is the same as the virtual read pointer virtual rd ptr, the FIFO controller 120 may determine that the FIFO memory 110 is empty.

The FIFO memory 110 may also provide a write pointer and a read pointer to each of the In FIFO memory 111, the Out FIFO memory 112, and the main FIFO memory 113. In one example embodiment, when a difference between the write pointer and the read pointer corresponds to the depth of one or more of the FIFO memories 111 through 113, the FIFO controller 120 may determine that the one or more of the FIFO memories 111 through 113 is full. In one example embodiment, when the write pointer and the read pointer of one or more of the FIFO memories 111 through 113 point to the same address, the FIFO controller 120 may determine that the one or more of the FIFO memories 111 through 113 is empty.

The Out FIFO manager 122 may output data stored in the Out FIFO memory 112 to the external device or output data stored in the main FIFO memory 113 to the external device. In addition, the Out FIFO manager 122 may output data received from the In FIFO manager 121 to the external device.

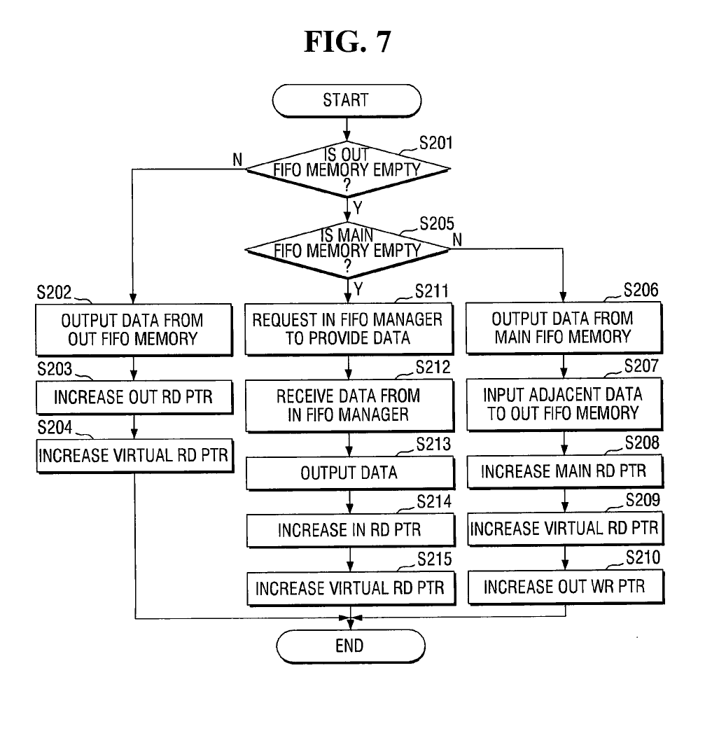

FIG. 7 is a flowchart illustrating a data output method of the memory system 100, according to an example embodiment.

Referring to FIG. 7, when a data output command is received from an external device, the Out FIFO manager 122 may determine whether the Out FIFO memory 112 is empty (S201). The Out FIFO manager 122 may determine whether the Out FIFO memory 112 is empty or whether data exists in the Out FIFO memory 112 by comparing an output read pointer out rd ptr and an output write pointer out wr ptr of the Out FIFO memory 112.

If the Out FIFO memory 112 is not empty, the Out FIFO manager 122 may output data from the Out FIFO memory 112 and may transmit the output data to the external device (S202). Then, the Out FIFO manager 122 may increase the output read pointer out rd ptr (by, e.g., one) (S203) and increase the virtual read pointer virtual rd ptr (S204).

If the Out FIFO memory 112 is empty, the Out FIFO manager 122 may determine whether the main FIFO memory 113 is empty (S205). The Out FIFO manager 122 may determine whether the main FIFO memory 113 is empty or whether data exists in the main FIFO memory 113 by comparing a main read pointer main rd ptr and a main write pointer main wr ptr.

If the main FIFO memory 113 is not empty, the Out FIFO manager 122 may output data from the main FIFO memory 113 and may transmit the output data to the external device (S206). Here, since the width of the main FIFO memory 113 is twice the width of the Out FIFO memory 112, the Out FIFO manager 122 may transmit first data (e.g., most significant bit (MSB) data) to the external device and may input adjacent second data (e.g., least significant bit (LSB) data) to the Out FIFO memory 112 (S207). Then, the Out FIFO manager 122 may increase the main read pointer main rd ptr (by, e.g., one) (S208), increase the virtual read pointer virtual rd ptr (S209) and increase the output write pointer out wr ptr (S210).

If the main FIFO memory 113 is empty, the Out FIFO manager 122 may request the In FIFO manager 121 to provide data (S211). Accordingly, the Out FIFO manager 122 may receive data stored in the In FIFO memory 111 from the In FIFO manager 121 (S212) and may output the received data to the external device (S213). Then, the Out FIFO manager 122 may increase the input read pointer in rd ptr (operation 5214) and increase the virtual read pointer virtual rd ptr (S215).

When the Out FIFO memory 112, the main FIFO memory 113, and the In FIFO memory 111 are empty, the FIFO memory 110 is empty. Therefore, the Out FIFO manager 122 may identify, in advance, whether the FIFO memory 110 is empty by comparing the virtual read pointer virtual rd ptr and the virtual write pointer virtual wr ptr. In such case, the FIFO controller 120 may transmit an empty signal indicating that the FIFO memory 110 is empty to the external device.

In one example embodiment, when the Out FIFO manager 122 outputs data stored in the main FIFO memory 113 and transmits the output data to the external device, a bubble may be created because the driving frequency of the main FIFO memory 113 is relatively low.

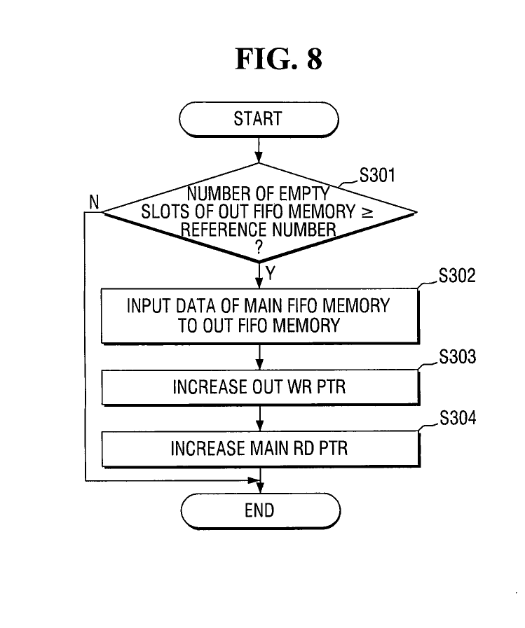

FIG. 8 is a flowchart illustrating an application example of the data output method of FIG. 7, according to an example embodiment. For simplicity, the following description will focus on differences from FIG. 7.

Referring to FIG. 8, the Out FIFO manager 122 may determine whether the number of empty slots of the Out FIFO memory 112 is equal to or greater than a reference number (S301). A slot may correspond to a storage unit of the Out FIFO memory 112. The reference number may correspond to a value (e.g., 2) of the above-described n.

In one example embodiment, the number of empty slots of the Out FIFO memory 112 is equal to or greater than the reference number, the Out FIFO manager 122 may output data stored in the main FIFO memory 113 and input the data to the Out FIFO memory 112 (S302). Then, the Out FIFO manager 122 may increase the output write pointer out wr ptr (e.g., by 2) (S303) and increase the main read pointer main rd ptr (e.g., by one) (S304).

When the depth of the Out FIFO memory 112 is six or greater, the Out FIFO manager 122 may not access the main FIFO memory 113. Therefore, the above-described bubble is not created.

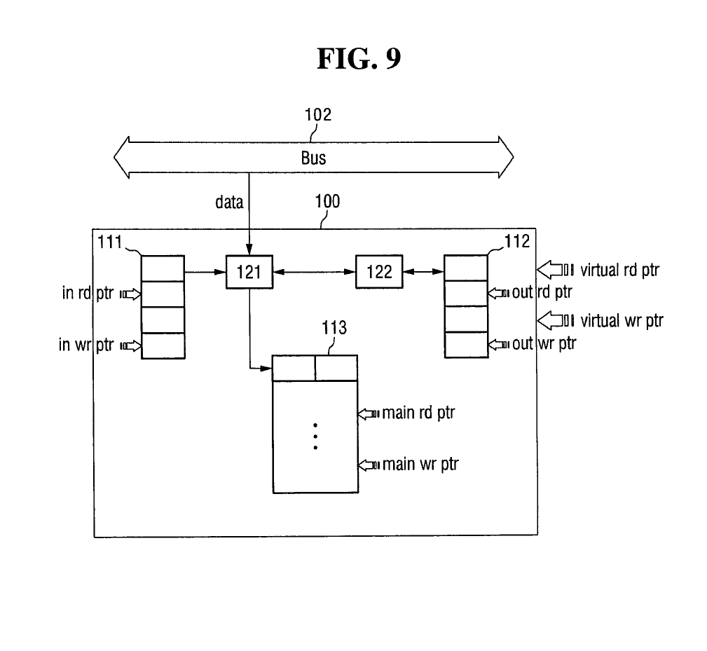

FIG. 9 is a diagram illustrating a data input operation of the memory system 100, according to an example embodiment.

Referring to FIG. 9, the In FIFO manager 121 may receive data from an external device using pointers.

The In FIFO manager 121 may store the data received from the external device in the In FIFO memory 111 or in the main FIFO memory 113. In addition, the In FIFO manager 121 may transmit the data received from the external device to the Out FIFO manager 122.

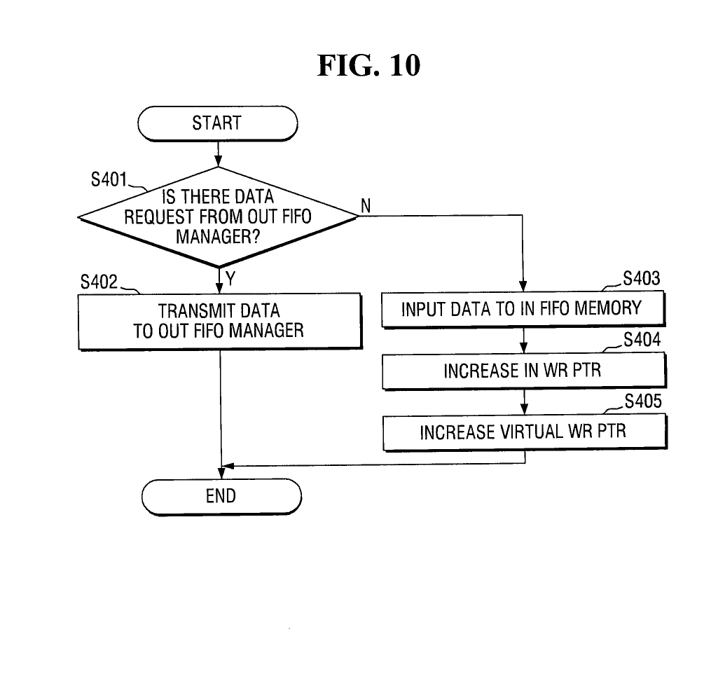

FIG. 10 is a flowchart illustrating a data input method of the memory system 100, according to an example embodiment.

Referring to FIG. 10, when a data input command is received from an external device, the In FIFO manager 121 may determine whether there is a data request from the Out FIFO manager 122 (S401).

If there is a data request from the out FIFO manager 122, the In FIFO manager 121 may immediately transmit data destined for the In FIFO memory 111 to the Out FIFO manager 122 (S402). Here, the In FIFO manager 121 may not store the data in the In FIFO memory 111, and the input read pointer in rd ptr and the input write pointer in wr ptr may not change. However, if the In FIFO manager 121 outputs data stored in the In FIFO memory 111 and transmits the output data to the Out FIFO manager 122 as described above, the input read pointer in rd ptr and the input write pointer in wr ptr may be changed.

If there is no data request from the out FIFO manager 122, the In FIFO manager 121 inputs the data received from the external device to the In FIFO memory 111 (S403). Accordingly, the In FIFO manager 121 may increase the input write pointer in wr ptr (e.g., by one) (S404) and increase the virtual write pointer virtual wr ptr (S405).

The In FIFO manager 121 may identify, in advance, whether the FIFO memory 110 is full by comparing the virtual read pointer virtual rd ptr and the virtual write pointer virtual wr ptr. When the FIFO memory 110 is full, the FIFO controller 120 may transmit a full signal indicating that the FIFO memory 110 is full to the external device. In such case, the In FIFO manager 121 may delay inputting the data until the FIFO memory 110 becomes available.

If the depth of the In FIFO memory 111 is relatively short, the In FIFO memory 111 may become full even when the FIFO memory 110 is not full. Therefore, it may not be possible to store data received from the external device.

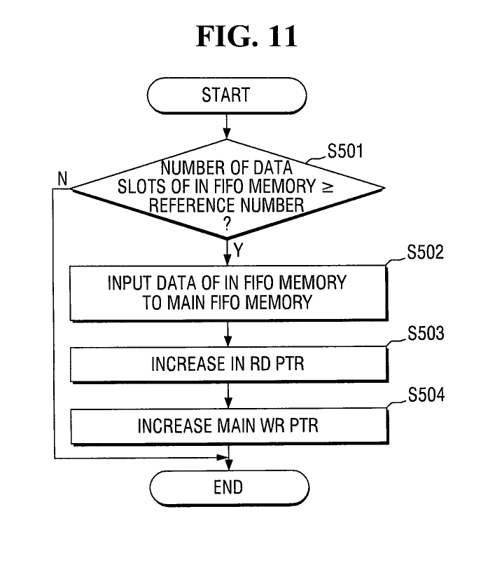

FIG. 11 is a flowchart illustrating an application example of the data input method of FIG. 10, according to an example embodiment. For simplicity, the following description will focus on differences from FIG. 10.

Referring to FIG. 11, the In FIFO manager 121 may determine whether the number of data slots of the In FIFO memory 111 is equal to or greater than a reference number (S501). A data slot may correspond to a storage unit of data in the In FIFO memory 111. The reference number may correspond to the value (e.g., 2) of the above-described n.

In one example embodiment, when the number of data slots of the In FIFO memory 111 is equal to or greater than the reference number, the In FIFO manager 121 may output data stored in the In FIFO memory 111 and input the data to the main FIFO memory 113 (S502). Then, the In FIFO manager 121 may increase the input read pointer in rd ptr (e.g., by two) (S503) and increase the main write pointer main wr ptr (e.g., by one) (S504).

If the depth of the In FIFO memory 111 is four or greater, data may be output from the In FIFO memory 111 to two or more storage units of the main FIFO memory 113. Therefore, the above-described situation does not occur.

Although not shown in FIGS. 6 and 9, the memory system 100 may further include a full signal generator which generates a signal indicating that the FIFO memory 110 is full, an empty signal generator which generates a signal indicating that the FIFO memory 110 is empty, an InFIFO full signal generator which generates a signal indicating that the In FIFO memory 111 is full, an InFIFO empty signal generator which generates a signal indicating that the In FIFO memory 111 is empty, an OutFIFO full signal generator which generates a signal indicating that the Out FIFO memory 112 is full, an OutFIFO empty signal generator which generates a signal indicating that the Out FIFO memory 112 is empty, a mainFIFO full signal generator which generates a signal indicating that the main FIFO memory 113 is full, and a mainFIFO empty signal generator which generates a signal indicating that the main FIFO memory 113 is empty.

In the memory system 100 described above, the main FIFO memory 113 may operate at a smaller frequency than a required frequency of the FIFO memory 110, and the width of the main FIFO memory 113 is n times the width of the FIFO memory 110. Accordingly, the driving frequency of the main FIFO memory 113 may be reduced to 1/n of the required frequency of the FIFO memory 110 without affecting the bandwidth of the FIFO memory 110.

The memory system 100 according to the example embodiments may be provided as one of various components of an electronic device such as a computer, an ultra-mobile PC (UMPC), a workstation, a net-book, a personal digital assistant (PDA), a portable computer, a web tablet, a wireless phone, a mobile phone, a smart phone, an e-book, a portable multimedia player (PMP), a portable game device, a navigation device, a black box, a digital camera, a three-dimensional television, a digital audio recorder, a digital audio player, a digital picture recorder, a digital picture player, a digital video recorder, a digital video player, a device capable of transmitting/receiving information in wireless environments, one of various electronic devices constituting a home network, one of various electronic devices constituting a computer network, one of various electronic devices constituting a telematics network, a radio frequency identification (RFID) device, or one of various components constituting a computing system.

The FIFO memory 110, the FIFO controller 120, or the memory system 100 may be packaged using various types of packages. For example, the FIFO memory 110, the FIFO controller 120, or the memory system 100 may be packaged using packages such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSOP), thin small outline package (TSOP), thin quad flat pack (TQFP), system in package (SIP), multichip package (MCP), wafer-level fabricated package (WFP), and wafer-level processed stack package (WSP).

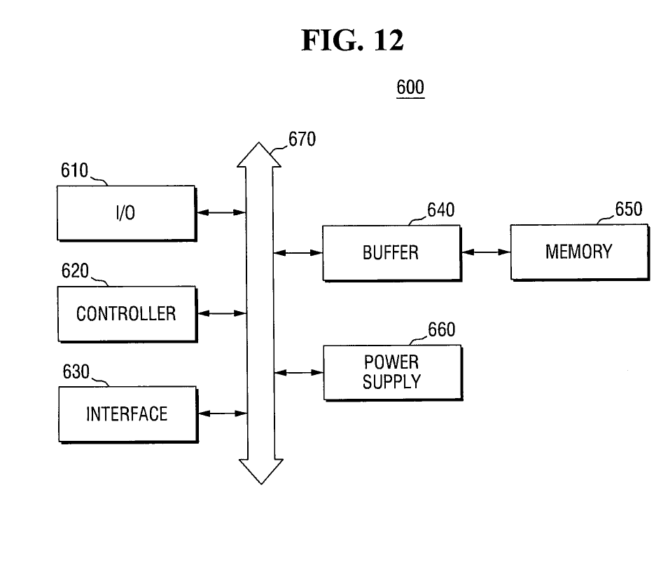

FIG. 12 is a block diagram of a computing system 600 including the memory system 100 of FIG. 1, according to an example embodiment.

Referring to FIG. 12, the computing system 600 may include an input/output (I/O) device 610, a controller 620, an interface 630, a buffer 640, a memory 650, a power supply 660, and a bus 670.

The I/O device 610, the controller 620, the interface 630, the buffer 640, and/or the power supply 660 may be coupled to each other through the bus 670. The bus 670 corresponds to a path through which data is transferred.

The 110 device 610 may include a keypad, a keyboard, and a display device to input and output data. To process data, the controller 620 may include at least one of a microprocessor, a digital signal processor, a microcontroller, and logic devices capable of performing similar functions to those of the above components. The interface 630 may transmit data to a communication network or receive data from the communication network. The interface 630 may be in a wired or wireless form. For example, the interface 630 may include an antenna or a wired/wireless transceiver. The memory 650 may store data and/or commands. The power supply 660 may convert power received from an external source and provide the converted power to the components 610 through 650. One or more power supplies 660 may be included in the computing system 600. The buffer 640 may temporarily store data input to or output from the memory 650 between the memory 650 and the bus 670.

Although not shown in the drawing, the computing system 600 may further include a high-speed DRAM and/or SRAM as an operation memory for improving the operation of the controller 620.

The memory system 100 according to the example embodiments may be provided within the buffer 640 or may be provided as a component of the I/O device 610, the controller 620, the interface 630, or the memory 650. The memory system 100 according to the example embodiments may be provided as a device that temporarily stores data between a first electronic system and a second electronic system which transmit and receive data. The memory system 100 may provide packet buffering, frequency coupling, and bus matching functions.

In FIG. 12, the computing system 600 may be integrated into one semiconductor device. For example, the I/O device 610, the controller 620, the interface 630, the buffer 640, the memory 650, and/or the power supply 660 may be integrated into one semiconductor device to form a system on chip (SoC). In another example, they may form an application processor (AP).

The computing system 600 may be applied to a FDA, a portable computer, a web tablet, a wireless phone, a mobile phone, a digital music player, a memory card, and all electronic products that may transmit and/or receive information in a wireless environment,

Operations or steps of a method or algorithm described in connection with the aspects disclosed herein may be embodied directly in hardware, in a software module executed by a processor, or in a combination of the two. A software module may reside in a RAM, a flash memory, a ROM, an electrically programmable ROM (EPROM), an electrically erasable programmable ROM (EEPROM), a register, a hard disk, a removable disk, a CD-ROM, or any other form of computer-readable recording medium known in the art. A recording medium may be coupled to a processor such that the processor may read information from and write information to the recording medium. A recording medium may be integral to the processor. The processor and the storage medium may reside in an application specific integrated circuit (ASIC). The ASIC may reside in user equipment. In the alternative, the processor and the storage medium may reside, as discrete components, in user equipment.

In concluding the detailed description, those skilled in the art will appreciate that many variations and modifications may be made to the example embodiments without substantially departing from the principles described herein. Therefore, the disclosed example embodiments are used in a generic and descriptive sense only.

What is claimed is:

1. A memory system comprising:
a hierarchical first-in first-out (FIFO) memory configured to store data; and
a FIFO controller configured to control inputting and outputting of data to and from the FIFO memory,
wherein the FIFO memory comprises:
a first layer including,
a high-speed input FIFO memory configured to receive data from an external device, and
a high-speed output FIFO memory configured to output data to the external device, and
a second layer including,
a main FIFO memory configured to receive data from the high-speed input FIFO memory and output data to the high-speed output FIFO memory.

2. The memory system of claim 1, wherein the FIFO controller comprises an input FIFO manager configured to,
input data to the high-speed input FIFO memory,
output data stored in the high-speed input FIFO memory, and
input the output data to the main FIFO memory.

3. The memory system of claim 2, wherein the FIFO controller further comprises:
an output FIFO manager configured to output data to the external device, wherein the input FIFO manager,
outputs data stored in the high-speed input FIFO memory, and
transmits the output data to the output FIFO manager in response to a request from the output FIFO manager.

4. The memory system of claim 2, wherein the FIFO controller further comprises an output FIFO manager configured to output data to the external device, wherein the input FIFO manager immediately transmits data destined for the high-speed input FIFO memory to the output FIFO manager in response to a request from the output FIFO manager.

5. The memory system of claim 1, wherein the FIFO controller comprises an output FIFO manager configured to,
output data stored in the main FIFO memory,
input the output data to the high-speed output FIFO memory, and
output data from the high-speed output FIFO memory.

6. The memory system of claim 1, wherein the FIFO memory is further configured to provide a virtual write pointer and a virtual read pointer to the external device.

7. The memory system of claim 6, wherein the FIFO memory is further configured to provide a write pointer and a read pointer corresponding to each of the high-speed input FIFO memory, the high-speed output FIFO memory, and the main FIFO memory.

8. The memory system of claim 1, wherein a length of a storage unit of the main FIFO memory is n times a length of a storage unit of the high-speed input FIFO memory and a length of a storage unit of the high-speed output FIFO memory, and
n is a natural number greater than one.

9. The memory system of claim 1, wherein the number of storage units of the main FIFO memory is greater than the number of storage units of the high-speed input FIFO memory and the number of storage units of the high-speed output FIFO memory.

10. The memory system of claim 9, wherein the number of storage units of the high-speed input FIFO memory is greater than the number of storage units of the high-speed output FIFO memory.

11. The memory system of claim 1, wherein the high-speed input FIFO memory and the high-speed output FIFO memory operate at a first frequency, and
the main FIFO memory operates at a second frequency, the second frequency being different from the first frequency.

12. The memory system of claim 11, wherein the first frequency is higher than the second frequency.

13. A system on chip (SoC) comprising:
a first electronic system configured to transmit data;
a second electronic system configured to receive the data; and
the memory system of claim 1 configured to temporarily store the data between the first electronic system and the second electronic system.

14. A memory comprising:
a first layer, operating at a first frequency, configured to at least one of receive data from an external device and output data to the external device; and
a second layer, operating at a second frequency, configured to at least one of receive the data from the first layer and output the data to the first layer.

15. The memory of claim 14, wherein the first layer includes:
an input first-in first-out (FIFO) memory configured to receive the data from the external device, and
an output FIFO memory configured to output the data to the external device.

16. The memory of claim 14, wherein the second layer includes:
a main FIFO memory configured to at least one of receive the data from the input FIFO memory and output the data to the input FIFO memory.

17. A memory system comprising:
the memory of claim 14, wherein the first layer and the second layer form a hierarchical first-in first-out (FIFO) memory, and
a FIFO controller configured to control inputting the data to the FIFO memory and outputting the data from the FIFO memory.

18. The memory of claim 14, wherein the first frequency has a higher value compared to the second frequency.

19. The memory of claim 15, wherein the number of storage units of the input FIFO memory is greater than the number of storage units of the output FIFO memory.

20. The memory of claim 15, wherein a length of a storage unit of a main FIFO memory of the second layer is greater than a length of a storage unit of the input FIFO memory and a length of a storage unit of the output FIFO memory.
